(19) United States
(12) Patent Application Publication
(10) Pub. No.: US 2026/0031539 A1
(43) Pub. Date: Jan. 29, 2026

(54) PARAMETRIC TIME-MODULATED ELECTRICALLY SMALL ANTENNA

(71) Applicant: The Regents of The University of Michigan, Ann Arbor, MI (US)

(72) Inventors: Zachary FRITTS, Ann Arbor, MI (US); Amirhossein BABAEE, Ann Arbor, MI (US); Cody SCARBOROUGH, Ann Arbor, MI (US); Steve M. YOUNG, Ann Arbor, MI (US); Anthony GRBIC, Ann Arbor, MI (US)

(21) Appl. No.: 18/782,904

(22) Filed: Jul. 24, 2024

(51) Int. Cl. H01Q 9/04; H01Q 1/40; H01Q 25/04

(52) U.S. Cl. CPC H01Q 9/0407; H01Q 1/405; H01Q 25/04

(57) ABSTRACT

An example antenna assembly includes an electrically small antenna having at least two sectors, wherein the at least two sectors are coupled to operate in at least a first mode and a second mode, the first mode is a radiative mode having a resonance, and the second mode is a non-radiative mode. The antenna assembly includes at least one time-varying reactive component having a parametric modulation frequency configured to at least partially couple the resonance of the radiative mode to the resonance of the non-radiative mode at a negative frequency, wherein the parametric modulation frequency of the at least one time-varying reactive component is greater than or less than a frequency value which exactly couples the resonance of the radiative mode to the negative frequency of the non-radiative mode.

### GOVERNMENT LICENSE RIGHTS

This invention was made with government support under 2241144 awarded by the National Science Foundation, and under N66001-22-C-4507 awarded by the U.S. Department of Defense, Defense Advanced Research Projects Agency. The government has certain rights in the invention.

### FIELD

The present disclosure relates to parametric time-modulated electrically small antennas.

### BACKGROUND

For many communications and sensing applications, it is desirable to have an antenna which is small compared to the operating wavelength. However, there are well-known limits on the quality factors, bandwidths, and efficiencies of electrically small antennas.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An example antenna assembly includes an electrically small antenna having at least two sectors, wherein the at least two sectors are coupled to operate in at least a first mode and a second mode, the first mode is a radiative mode having a resonance, and the second mode is a non-radiative mode. The antenna assembly includes at least one time-varying reactive component having a parametric modulation frequency configured to at least partially couple the resonance of the radiative mode to the resonance of the non-radiative mode at a negative frequency, wherein the parametric modulation frequency of the at least one time-varying reactive component is greater than or less than a frequency value which exactly couples the resonance of the radiative mode to the negative frequency of the non-radiative mode.

In some examples, the non-radiative mode has a high quality factor resonance with a low radiation efficiency. In some examples, the at least two sectors are capacitively coupled to operate in the first mode and the second mode. In some examples, the at least two sectors are inductively coupled to operate in the first mode and the second mode.

In some examples, the at least one time-varying reactive component includes a time-varying capacitor. In some examples, the at least one time-varying reactive component includes at least one of a varactor diode, a ferroelectric material, a transistor, a piezoelectric material, a Josephson junction, a non-linear element, or a microelectromechanical system.

In some examples, the at least one time-varying reactive component is coupled to one or more of the at least two sectors of the electrically small antenna. In some examples, the antenna assembly includes a port electrically coupled with the at least two sectors, wherein the at least one time-varying reactive component is coupled to a port of the electrically small antenna.

In some examples, a wave number in a radiating medium multiplied by a radius of a smallest sphere enclosing the electrically small antenna is less than 0.5.

In some examples, the at least two sectors are coupled to operate in at least a third mode, the first mode and the second mode are coupled according to a first modulation frequency, and the first mode and a third mode are coupled according to a second modulation frequency different from the first modulation frequency.

In some examples, the parametric modulation frequency of at least one time-varying reactive component is less than a frequency value which exactly couples the resonance of the radiative mode to the negative frequency of the non-radiative mode.

In some examples, the parametric modulation frequency of the at least one time-varying reactive component is greater than a frequency value which exactly couples the resonance of the radiative mode to the negative frequency of the non-radiative mode.

In some examples, the electrically small antenna is a rotationally symmetric electrically small antenna, and the electrically small antenna is divided into N identical sectors.

In some examples, components in each of the at least two sectors are modulated with the same temporal modulation periods. In some examples, each of the at least two sectors has a time delay in its modulation waveform as compared to other ones of the at least two sectors.

In some examples, the electrically small antenna is configured to operate according to spatially-discrete traveling-wave modulation. In some examples, the at least two sectors are electrically connected in parallel. In some examples, a topology of the electrically small antenna is at least one of a top hat monopole, a square antenna, or a patch antenna.

An example antenna assembly includes an electrically small antenna having at least two sectors, wherein the at least two sectors are coupled to operate in at least a first mode and a second mode, and at least one time-varying reactive component having a parametric modulation frequency configured to at least partially couple a resonance of the first mode to a negative frequency resonance of the second mode, wherein the parametric modulation frequency of the at least one time-varying reactive component is greater than or less than a frequency value which exactly couples the resonance of the first mode to the negative frequency resonance of the second mode, to operate the electrically small antenna according to spatially-discrete traveling-wave modulation.

An example antenna assembly includes an electrically small antenna having at least two sectors, wherein the at least two sectors are coupled to operate in at least a first mode and a second mode, and an electrically small antenna having at least two sectors, wherein the at least two sectors are coupled to operate in at least a first mode and a second mode, and at least one time-varying reactive component having a parametric modulation frequency configured to at least partially couple a resonance of the first mode to a negative frequency resonance of the second mode, wherein the parametric modulation frequency of the at least one time-varying reactive component is greater than or less than a frequency value which exactly couples the resonance of the first mode to the negative frequency resonance of the second mode, and wherein the at least two sectors are electrically connected in parallel.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a circuit diagram of an example electrically small antenna including parametric time-modulated elements.

FIG. 2 is an equivalent circuit diagram of the example electrically small antenna of FIG. 1.

FIG. 3 is a circuit diagram of an example external circuit which may be utilized as an idler to couple with an antenna mode.

FIG. 4 is a circuit diagram of an example antenna having a dome structure.

FIG. 5 is a circuit diagram of an example circular electrically small antenna having two sectors.

FIG. 6 is a circuit diagram of an example circular electrically small antenna having three sectors.

FIG. 7 is a circuit diagram of an example circular electrically small antenna having four sectors.

FIG. 8 is a circuit diagram of an example square electrically small antenna having two sectors.

FIG. 9 is a circuit diagram of an example triangular electrically small antenna having three sectors.

FIG. 10 is a circuit diagram of an example square electrically small antenna having four sectors.

In the drawings, reference numbers may be reused to identify similar and/or identical elements.

### DETAILED DESCRIPTION

Described herein are some example embodiments of electrically small antennas which use time-varying components to achieve a larger bandwidth-efficiency product than similarly sized conventional antennas, as well as a method for designing such time-varying antennas. The method may be applied, for example, to electrically small antennas (ESAs) that have one mode which is designed to radiate efficiently (e.g., a radiative mode) and at least one mode that is designed to have a very low (such as less than 1%) radiation efficiency (e.g., a non-radiative mode).

Parametrically time-varying components may be placed on the antenna structure, or at one or more ports of the antenna. These components may have a reactive nature, rather than resistive, such as time-varying capacitors for example. The parametric modulation frequency of each time-varying reactive component may be chosen to couple the resonance of the radiative mode to the negative-frequency resonance of at least one of the non-radiative modes.

By choosing each modulation frequency to be either larger or smaller than a value required to exactly couple the resonances of the modes, the impedance matching bandwidth at the antenna port may be increased. The bandwidth over which the antenna radiates efficiently may also be increased. Coupling the radiative mode to non-radiative mode(s) may suppress radiation of spurious harmonics.

In some example embodiments, a rotationally symmetric electrically small antenna is divided into N identical sectors. Parametrically time-varying components in each sector are modulated with the same temporal modulation period(s). Time-varying components in each sector have a time-delay in the modulation waveform compared to other sectors, yielding a form of parametric space-time modulation known as spatially-discrete traveling-wave modulation (SDTWM).

If the sectors are connected in parallel, many harmonics of the time-varying system may be inhibited or prevented by symmetry from exiting the port of the antenna. This may also protect the non-radiative modes from being damped by coupling out of the antenna port.

Some example details of electrically small antennas are described in “Small Antenna Bandwidth-Efficiency Enhancement Realized using Time Variation (SABER-TV)”, L. van Nieuwstadt, A. Grbic, Z. Fritts, S. M. Young, B. Slovick, R. Sparr, IARPA EQUAL-P Program Kickoff Meeting, Aug. 23, 2022; “Increasing the efficiency-bandwidth of small antennas by coupling radiative and nonradiative modes using time-variation”, Z. Fritts, S. M. Young, C. Scarborough, and A. Grbic, 2023 United States National Committee of URSI National Radio Science Meeting (USNC-URSI NRSM), Boulder, CO, USA, 2023, pp. 77-78; “Increasing the efficiency-bandwidth product of electrically-small antennas by time-dependent parametric coupling of characteristic modes”, S. M. Young, Z. Fritts, and A. Grbic, 2023 IEEE AP-S International Symposium, Portland, OR, USA, Jul. 24, 2023, 2097; “Small Antenna Bandwidth-Efficiency Enhancement Realized using Time Variation (SABER-TV)”, L. van Nieuwstadt, A. Grbic, A. Babaee, A. Bahr, H. Chen, G. Chensue, Z. Fritts, J. Hellhake, J. Kirschenheiter, J. Ruiz-Garcia, J. Siegel, B. Slovick, R. Sparr, R. Strohman, S. M. Young, IARPA EQUAL-P Program PI Workshop, Sep. 19, 2023; and “Increasing the efficiency-bandwidth product and impedance bandwidth of electrically small antennas through parametric space-time variation”, Z. Fritts, A. Babaee, S. M. Young, and A. Grbic, 18th European Conference on Antennas and Propagation (EuCAP), Glasgow, Scotland, UK, 2024. Each of the above references are incorporated herein by reference.

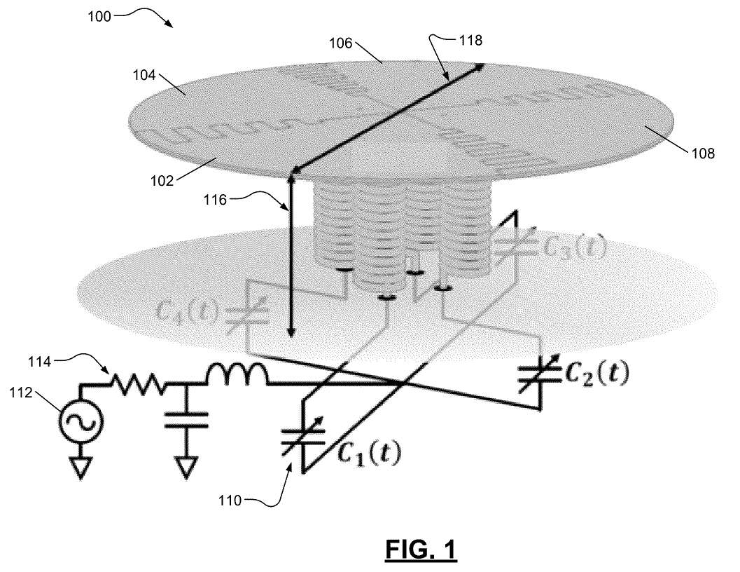

FIG. 1 is a circuit diagram of an example antenna assembly 100 including parametric time-modulated elements. The antenna assembly 100 may be an electrically small antenna. For example, a size of the antenna relative to a radiating wavelength may be small, such as a wave number in the medium surrounding the antenna assembly 100 times a radius of the antenna assembly 100 being less than 0.5.

The antenna assembly 100 includes four sectors 102, 104, 106 and 108, although other example embodiments may include more or fewer sectors (such as two sectors, three sectors, or five or more sectors). The sectors are coupled to operate in at least a first mode and a second mode. The first mode is a radiative mode having a resonance, and the second mode is a non-radiative mode.

The antenna assembly includes at least one time-varying reactive component 110. Although FIG. 1 illustrates four time-varying reactive components 110 (e.g., C1, C2, C3 and C4), other example embodiments may include more or fewer time-varying reactive components 110, which may correspond to a number of sectors of the antenna assembly (or a multiple of the number of sectors).

The time-varying reactive components 110 may each have a parametric modulation frequency configured to at least partially couple the resonance of the radiative mode to the resonance of the non-radiative mode at a negative frequency. In some examples, the parametric modulation frequency of the at least one time-varying reactive component is greater than or less than a frequency value which exactly couples the resonance of the radiative mode to the negative frequency of the non-radiative mode.

In various implementations, the non-radiative mode has a high quality factor resonance with a low radiation efficiency. One or more of the sectors 102, 104, 106 and 108 may be capacitively coupled to operate in the first mode and the second mode, and/or inductively coupled to operate in the first mode and the second mode.

As shown in FIG. 1, each time-varying reactive component 110 may be a time-varying capacitor, which changes a capacitance value over time (e.g., C1(t), C2 (t), C3 (t), C4 (t)). In other examples, the time-varying reactive component(s) may include an inductor, a varactor diode, a ferroelectric material, a transistor, a piezoelectric material, a Josephson junction, a non-linear element, a microelectromechanical system, etc.

In the example of FIG. 1, each time-varying reactive component 110 is coupled with a respective one of the sectors 102, 104, 106 and 108. In other examples, a time-varying reactive component may be coupled with a port 112 of the antenna assembly 100. For example, the antenna assembly 100 may include a port 112 which receives and/or generates an electrical signal. In this example, the resistor represents the characteristic impedance of port 112 (e.g., a 50 ohm resistor). One or more capacitors, one or more inductors, etc., may be coupled between the port 112 and the sectors 102, 104, 106 and 108 of the antenna assembly 100.

In some examples, a wave number in a radiating medium multiplied by a radius of a smallest sphere enclosing the electrically small antenna is less than 0.5. In various implementations, the sectors are coupled to operate in at least a third mode, the first mode and the second mode are coupled according to a first modulation frequency, and the first mode and a third mode are coupled according to a second modulation frequency different from the first modulation frequency.

For example, the parametric modulation frequency of at least one time-varying reactive component 110 may be less than a frequency value which exactly couples the resonance of the radiative mode to the negative frequency of the non-radiative mode. The parametric modulation frequency of the at least one time-varying reactive component 110 may be greater than a frequency value which exactly couples the resonance of the radiative mode to the negative frequency of the non-radiative mode.

In some examples, the antenna assembly 100 is a rotationally symmetric electrically small antenna, and the electrically small antenna is divided into N identical sectors (such as the four identical sectors illustrated in FIG. 1, although other example embodiments may include more or fewer sectors). Each of the time-varying reactive components 110 associated with the respective sectors 102, 104, 106 and 108 may be modulated with the same temporal modulation periods. In some examples, each sector has a time delay in its modulation waveform as compared to other ones of sectors. In some examples, the antenna assembly 100 is configured to operate according to spatially-discrete traveling-wave modulation (SDTWM).

As shown in FIG. 1, each of the sectors 102, 104, 106 and 108 may be electrically connected in parallel. This isolates the non-radiative modes from the source impedance 114 to maintain a high quality factor. Although FIG. 1 illustrates a top hat monopole, other example embodiments may include any suitable antenna topology, such as a square antenna, or a patch antenna. FIG. 1 illustrates the antenna having a height 116 (e.g., 20 millimeters), and a diameter (e.g., 60 millimeters), although other example embodiments may have any suitable dimensions.

As mentioned above, the antenna assembly 100 is a four-sector, top-hat loaded monopole above a ground plane. In each sector the vertical monopolar element is twisted into a helix to inductively load the antenna and reduce its electrical size to ka=0.253, for example, at the fundamental self-resonant frequency of 335 MHz. A time-varying capacitor is placed in series with the vertical helix in each sector, and the capacitors are then joined at a single feed point.

An L-network at this feed point matches the input impedance of the time-invariant version of the antenna to 50 ohms, for example. Since the four sectors are in such close proximity, they are strongly coupled to each other. This coupling is predominantly capacitive coupling between the top hats of each sector. It is tuned by the interdigitations between the top hats.

Modes of the antenna assembly 100 may be discretized versions of orbital angular momentum (OAM) modes, where each mode is characterized by an azimuthal index m. For the m^{th} mode, the voltage and current in adjacent sectors may have an identical magnitude and a progressive phase shift of m times ninety degrees. Each mode has a modal resonant frequency om at which the modal admittance is maximized and becomes purely real. Some modes may be degenerate, since they represent OAM modes with the same wavenumber but opposite rotational senses.

In some examples, only the fundamental m=0 mode couples efficiently to the far field, and all other modes are predominantly confined to the near field of the antenna. Therefore, the m=0 mode may be considered as a “radiative” or “bright” mode and, the other modes “nonradiative” or “dark” modes. This is because the currents in each sector are in-phase for the m=0 mode, causing the four sectors to act in unison and creating a radiation pattern like that of a single top-hat loaded monopole. The m=0 mode may have a radiation frequency of 83%, for example, according to simulations, with a bandwidth of 86% of the Gustafsson limit for a vertically polarized cylindrical antenna. Other example embodiments may use other suitable antenna topologies, such as coupled looped antennas, planar sectorized antennas, etc.

For the non-radiative modes, the individual contributions to the far field from each sector sum destructively. Consequently, these modes have vanishingly small radiation efficiencies. The radiation efficiencies of the non-radiative modes may be, for example, 0.41% (m=1, 3) and 0.003% (m=2).

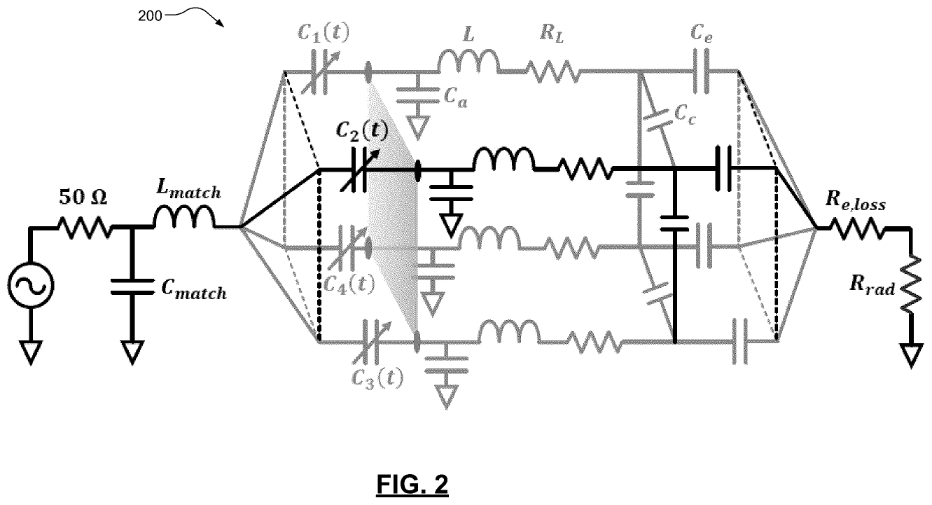

FIG. 2 is an equivalent circuit diagram 200 of the example antenna assembly 100 of FIG. 1. In FIG. 2, inductor L represents the inductance of the vertical helix, capacitor Ce the capacitance of the fringing fields between the top hat and the ground plane, capacitor Cc is the intersector coupling capacitance, and capacitance Ca is the parasitic capacitance between the feeds and the ground plane.

The four-path nature of the circuit in FIG. 2 illustrates why solely the m=0 mode is radiative in the example antenna assembly 100. The current through the radiation resistance is the sum of the currents in the four paths of the circuit. Suppose that the current in path n is related to the current in path n−1 by a phase shift of m times ninety degrees. Then, the total current through the radiation resistance is zero except when m=0. Consequently, only the m=0 mode may contribute to radiated power in this example.

Cancellation of currents for modes m not equal to 0 applies to currents entering or exiting the node to the right of the inductor Lmatch in FIG. 2. As a result, the non-radiative modes are isolated from the matching network and from the 50 ohm source impedance. This isolation is significant because it inhibits or prevents the source impedance from damping the non-radiative modes. This allows them to have the high quality factor needed to serve as low loss idler tanks within parametric processes.

Spatially-discrete traveling-wave modulation (SDTWM) is a class of space-time modulation in which one or more parameters of each unit cell in a periodic structure are varied in time, but with a time-delay in the modulation waveform between adjacent unit cells. This form of space-time modulation allows us to selectively couple the radiating mode of the antenna to specific non-radiating modes. Both time- and space-variation may be used in order to couple different modal resonances of the antenna, as these occur at different (temporal) frequencies, as well as different angular (spatial) wavenumbers.

In some examples, harmonics of the operating frequency of the antenna can be confined to non-radiating modes, suppressing the radiation of undesired spurious harmonics. This property of SDTWM may be used to develop an antenna that performs efficient subharmonic mixing by confining the first and second modulation harmonics to non-radiating modes of the antenna, while allowing the third harmonic to fall into a radiating mode.

A modulation frequency may be selected to couple the resonance of the radiative mode (ω0) with the negative-frequency image of the resonance of a non-radiative mode (e.g., ω1), which means that one of the harmonics of ω0 may be equal to −ω1. Since this modulation frequency can be used to generate negative-resistance parametric amplification, it may be referred to as “negative-R modulation”. If the modulation frequency is chosen to deviate from this value by some frequency A, then it may be referred to as “detuned negative-R modulation.”

Detuned negative-R modulation may have an effect on the radiated power spectrum of the antenna assembly 100. For example, for low modulation depths, there may be a single modulation frequency for which the gain (radiated power normalized by incident power) attains its maximum value. This modulation frequency corresponds to the case when the m=0 and m=1 modal resonances are exactly coupled, without detuning. The peak with the largest gain may be located exactly above the center of the LTI m=0 resonance.

For larger modulation depths, there may be two modulation frequencies at which maximum gain is achieved. One of these modulation frequencies has a positive detuning parameter and the other has a negative detuning parameter. The modulation depth at which this transition occurs may be referred to as a critical modulation depth.

At modulation depths that are larger than the critical modulation depth, it is possible to choose a detuned modulation frequency such that the antenna exhibits low gain, but a large radiating bandwidth. In addition to determining the radiated power spectrum, the choice of the modulation frequency at a particular modulation depth also determines the reflected power spectrum. It is possible to select a detuned modulation frequency for which the total power reflected back to the RF source remains less than a threshold. By using SDTWM to couple the radiative mode to a non-radiative mode, it is possible to improve the matching and radiating bandwidths of the time-varying antenna over those of the time-invariant antenna.

In an example single-tone modulation scheme, a modulation index may be selected as p=1 in order to couple the radiating mode to the m=1 mode. The modulation frequency may be detuned by any suitable value, such as about −4.0 MHz. The reflected power from the time-varying antenna may remain below the threshold over a bandwidth that is much larger than that obtained by the LTI antenna. Over a passband, the radiated power from the antenna may be relatively uniform, with no significant passband ripple.

In some examples, the power supplied by the modulation source does not make up a significant fraction of the radiated power, except near the lowest edge of the passband, which implies that the modulation source is not simply amplifying RF signal power that happens to be accepted into the antenna. Rather, the match provided by the parametric modulation allows the incident RF power to radiate through the antenna, instead of being reflected back to the RF source. In various implementations, the realized efficiency of the time-varying antenna (e.g., the antenna assembly 100 of FIG. 1) may be larger than the realized efficiency of the LTI antenna, because the realized efficiency penalizes mismatch. Both radiation and realized efficiency-bandwidth products are increased by a factor of more than, e.g., 4.4 for the time-varying antenna as compared to the linear time-invariant antenna.

Coupling the radiative mode to two different non-radiative modes simultaneously can yield a broader bandwidth match that is symmetric about the center of the passband. This effect can be achieved by modulating the capacitance in each sector with two different modulation frequencies, fmod,1 and fmod,2.

One frequency couples the radiative mode to the m=1 mode with a positive detuning parameter, and the other couples the radiative mode to the m=2 mode with a negative detuning parameter. This two-tone modulation scheme may extend the matching and radiation bandwidths of the time-varying antenna beyond those of the antenna with the single-tone modulation scheme.

The time-varying capacitance on sector n for coupling the radiative mode to two different non-radiative modes takes the form:

$${C}_{n} ( t ) = {C}_{0} + 2 {M}_{1} {C}_{0} cos ( {ω}_{mod , 1} t - n \frac{2 π {p}_{1}}{4} ) + 2 {M}_{2} {C}_{0} cos ( {ω}_{mod , 2} t - n \frac{2 π {p}_{2}}{4} ) .$$

Since ω mod,1 couples the radiative mode to the m=1 mode, the modulation index on tone 1 is p1=1. Similarly, since ω mod,2 will couple the radiative mode to the m=2 mode, the modulation index on tone 2 is p2=2. The modulation frequencies ω mod,1 and ω mod,2 are detuned positively and negatively, respectively.

Multiple choices of modulation depths M1, M2 and modulation frequencies fmod,1, fmod,2 can yield the desired behavior. Heuristically, increasing the modulation depth of one of the modulation frequencies also alters the effective modulation depth of the other modulation frequency. Therefore, choosing appropriate combinations of modulation parameters may be an iterative process.

Similar to single-tone modulation, in two-tone modulation the time-varying antenna can radiate power over a broader bandwidth than the LTI antenna while maintaining an effective impedance match at the RF input of the antenna. In this case, the response of the time-varying antenna may be roughly symmetric about the center of the passband.

Both of the example negative-R modulation schemes discussed above allow the antenna to radiate an RF signal efficiently over a bandwidth that is much wider than that of the LTI antenna. Since the radiation and realized efficiencies may account for power supplied by the modulation source, the enhanced efficiency-bandwidth metrics do not come at the expense of a hidden power draw. Nor is the power supplied by the modulation simply amplifying the RF input signal. Rather, the parametric modulation provides an effective input impedance match to the antenna. This allows the time-varying antenna to radiate power that would have otherwise been reflected back to the RF source.

A main difference between the single-tone and two-tone modulation schemes is that the latter results in larger efficiency-bandwidth products (and yields symmetric passband responses). However, a comparison of the scheme results shows that coupling to two idler modes instead of one only increases the efficiency-bandwidth metrics by about 1 dB. Therefore, there are diminishing returns to increased modulation scheme complexity, just as there are diminishing returns in increasing the order of an LTI matching network.

Applying this constraint limits the combined magnitudes of modulation depths M1 and M2. Since larger modulation depths yield larger bandwidths, the constraint on the magnitude of the modulation depths limits the achieved bandwidth. The power radiated from the idler harmonics in both modulation schemes may be strongly suppressed (e.g., down by at least 30 dB from the signal power level).

In some examples, design parameters may be selected to suppress spurious harmonics, such as by ensuring that that the spurious harmonics do not fall near a resonance of the antenna. For example, re-tuning the matching network to a slightly different frequency may help avoid this higher-order resonant coupling. The second approach is to reduce the radiation efficiency of the antenna at the harmonic frequencies, such as by placing small slits in the conducting body of the antenna to selectively disrupt the current distributions excited by a given higher-order harmonic.

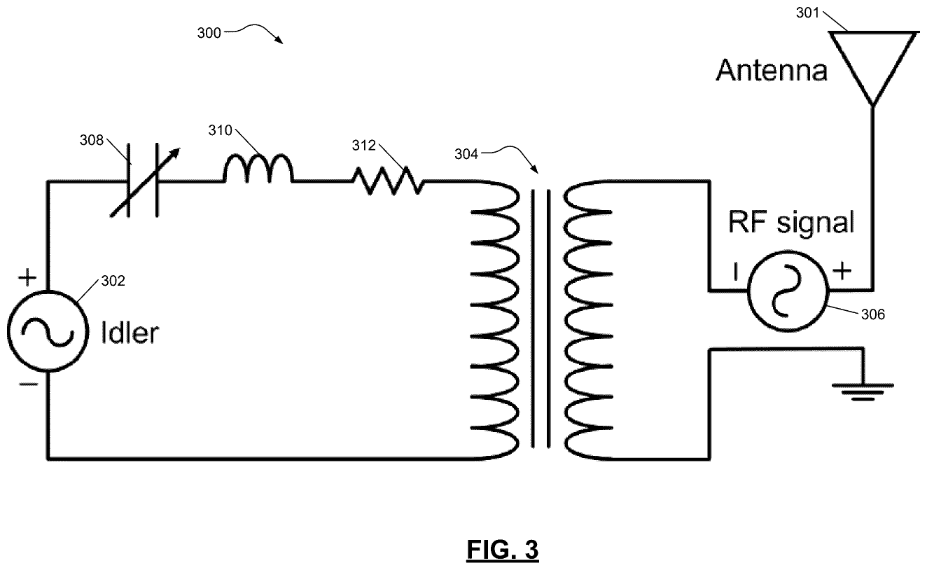

FIG. 3 is a circuit diagram of an example external circuit 300 which may be utilized as an idler to couple with an antenna mode. As shown in FIG. 3, the idler source 302 generates a signal which is provided though a transformer 304, to supply a radio frequency (RF) signal 306 for an antenna 301.

For example, the external circuit 300 may be coupled to supply a signal to the antenna assembly 100 of FIG. 1. The external circuit 300 may include one or more capacitors 308, inductors 310 and resistors 312 between the idler source 302 and the transformer 304.

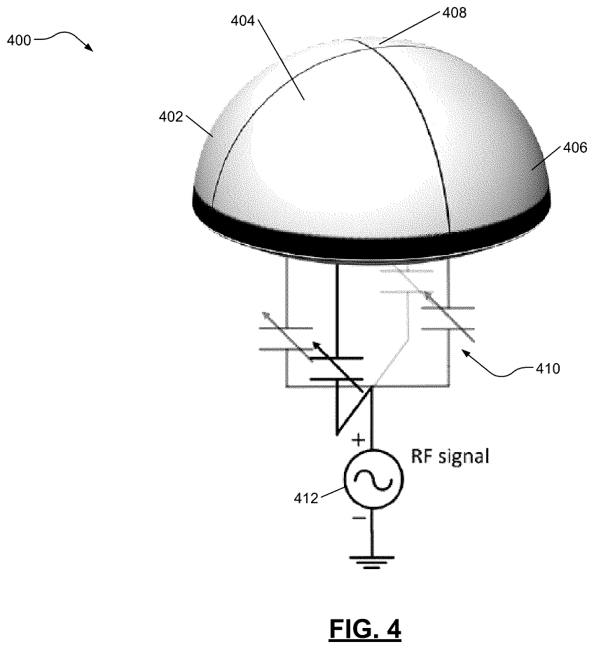

FIG. 4 is a circuit diagram of an example antenna 400 having a three-dimensional (e.g., dome) structure. The antenna 400 may be similar to the antenna assembly 100 of FIG. 1, but with a different structure. As shown in FIG. 4, the antenna 400 includes four sections 402, 404, 406 and 408, which are each three-dimensional (e.g., to define half of a sphere).

The antenna 400 includes multiple time-varying reactive components 410 (e.g., variable capacitors). Each time-varying reactive component 410 may be coupled with or associated with a different one of the sections 402, 404, 406 and 408. An RF signal 412 is connected to provide an RF driving signal to the antenna 400.

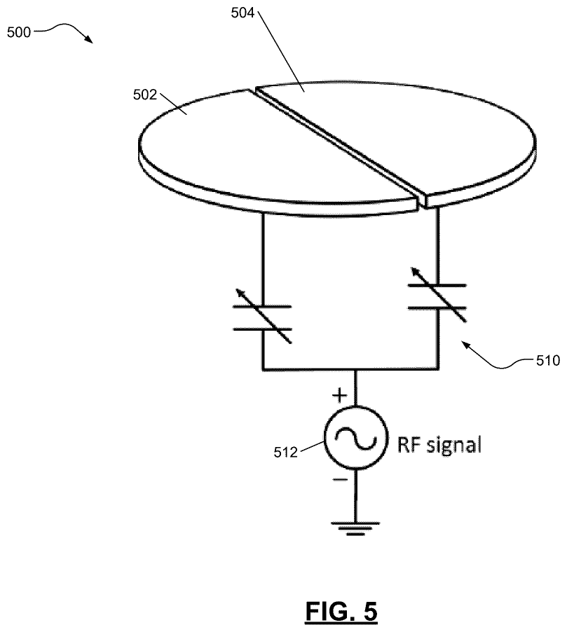

FIG. 5 is a circuit diagram of an example circular electrically small antenna 500 having two sectors 502 and 504. The electrically small antenna 500 may be similar to the antenna assembly 100 of FIG. 1, but with fewer sectors than the antenna assembly 100.

The antenna 500 includes multiple time-varying reactive components 510 (e.g., variable capacitors). Each time-varying reactive component 510 may be coupled with or associated with a different one of the sectors 502 and 504. An RF signal 512 is connected to provide an RF driving signal to the antenna 500.

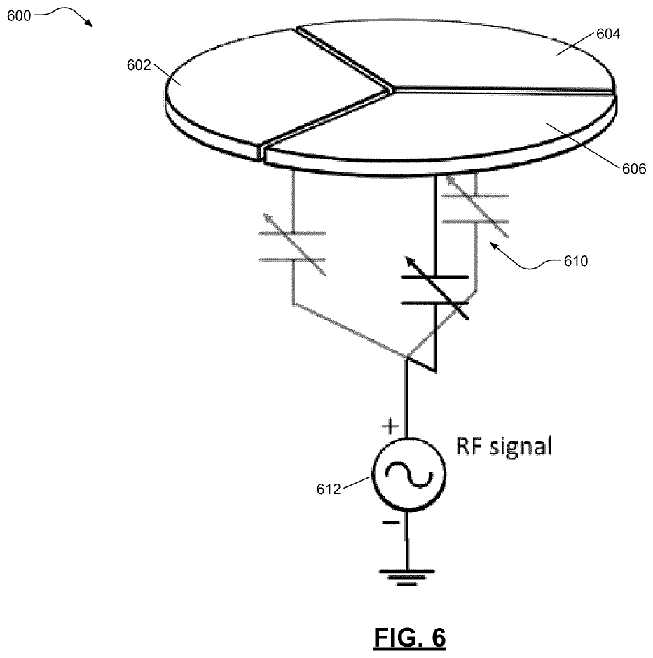

FIG. 6 is a circuit diagram of an example circular electrically small antenna 600 having three sectors 602, 604 and 606. The electrically small antenna 600 may be similar to the antenna 500 of FIG. 5, but with the circular portion divided into three sectors.

The antenna 600 includes multiple time-varying reactive components 610 (e.g., variable capacitors). Each time-varying reactive component 610 may be coupled with or associated with a different one of the sectors 602, 604 and 606. An RF signal 612 is connected to provide an RF driving signal to the antenna 600.

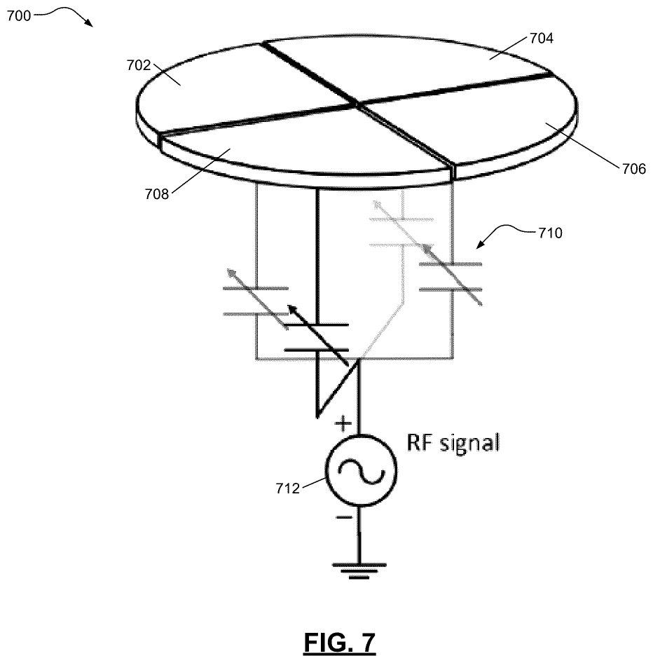

FIG. 7 is a circuit diagram of an example circular electrically small antenna 700 having four sectors 702, 704, 706 and 708. The electrically small antenna 700 may be similar to the antennas 500 and 600 of FIGS. 5 and 6, but with the circular portion divided into four sectors.

The antenna 700 includes multiple time-varying reactive components 710 (e.g., variable capacitors). Each time-varying reactive component 710 may be coupled with or associated with a different one of the sectors 702, 704, 706 and 708. An RF signal 712 is connected to provide an RF driving signal to the antenna 700.

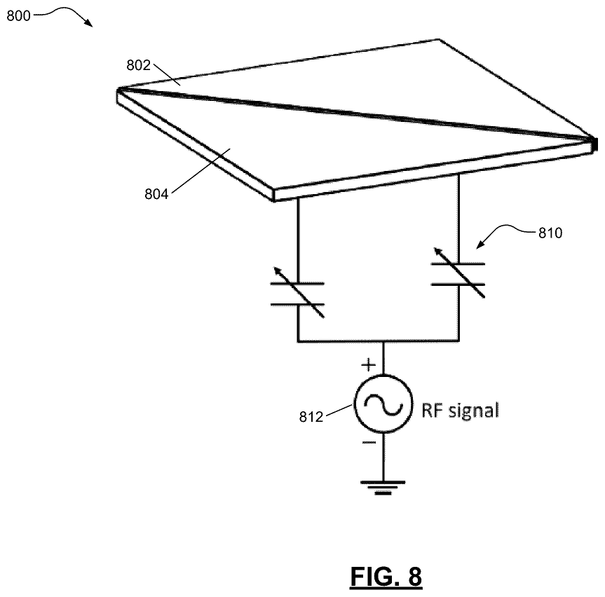

FIG. 8 is a circuit diagram of an example square electrically small antenna 800 having two sectors 802 and 804. The electrically small antenna 800 may be similar to the antenna assembly 100 of FIG. 1, but with fewer sectors than the antenna assembly 100 and a different shape of the radiating element.

The antenna 800 includes multiple time-varying reactive components 810 (e.g., variable capacitors). Each time-varying reactive component 810 may be coupled with or associated with a different one of the sectors 802 and 804. An RF signal 812 is connected to provide an RF driving signal to the antenna 800.

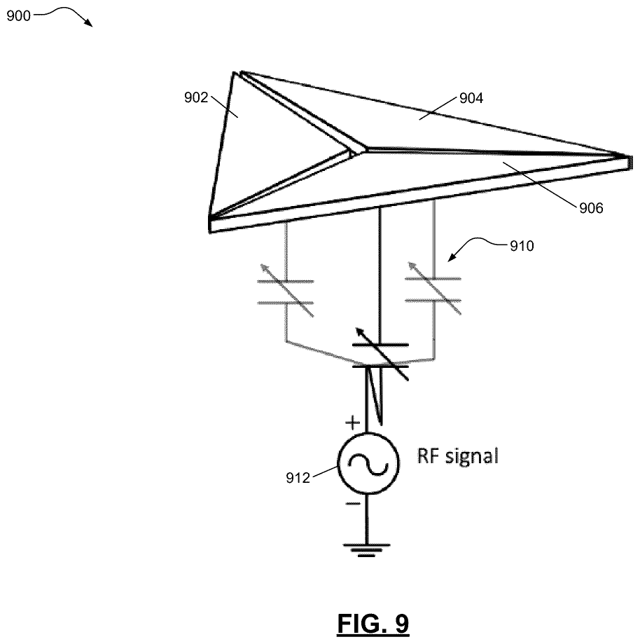

FIG. 9 is a circuit diagram of an example triangular electrically small antenna 900 having three sectors 902, 904 and 906. The antenna 900 includes multiple time-varying reactive components 910 (e.g., variable capacitors). Each time-varying reactive component 910 may be coupled with or associated with a different one of the sectors 902, 904 and 906. An RF signal 912 is connected to provide an RF driving signal to the antenna 900.

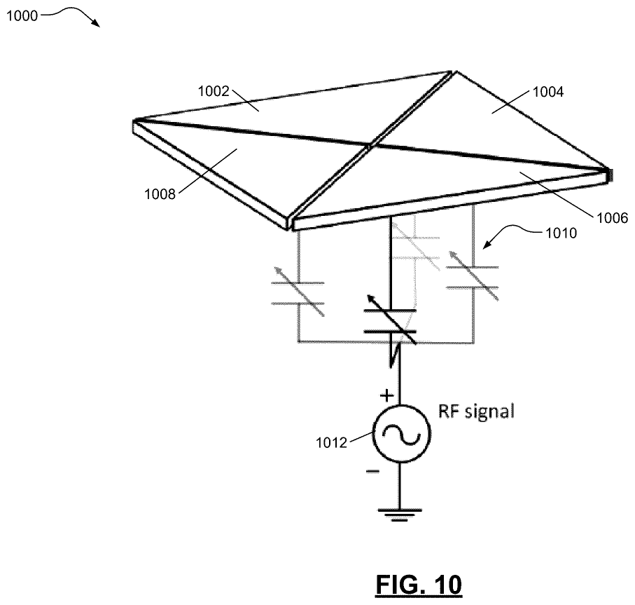

FIG. 10 is a circuit diagram of an example square electrically small antenna 1000 having four sectors 1002, 1004, 1006 and 1008. The electrically small antenna 1000 may be similar to the antennas 800 of FIG. 8, but with the square portion divided into four sectors.

The antenna 1000 includes multiple time-varying reactive components 1010 (e.g., variable capacitors). Each time-varying reactive component 1010 may be coupled with or associated with a different one of the sectors 1002, 1004, 1006 and 1008. An RF signal 1012 is connected to provide an RF driving signal to the antenna 1000.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An antenna assembly comprising:
an electrically small antenna having at least two sectors, wherein the at least two sectors are coupled to operate in at least a first mode and a second mode, the first mode is a radiative mode having a resonance, and the second mode is a non-radiative mode; and
at least one time-varying reactive component having a parametric modulation frequency configured to at least partially couple the resonance of the radiative mode to the resonance of the non-radiative mode at a negative frequency,
wherein the parametric modulation frequency of the at least one time-varying reactive component is greater than or less than a frequency value which exactly couples the resonance of the radiative mode to the negative frequency of the non-radiative mode.

2. The antenna assembly of claim 1, wherein the non-radiative mode has a high quality factor resonance with a low radiation efficiency.

3. The antenna assembly of claim 1, wherein the at least two sectors are capacitively coupled to operate in the first mode and the second mode.

4. The antenna assembly of claim 1, wherein the at least two sectors are inductively coupled to operate in the first mode and the second mode.

5. The antenna assembly of claim 1, wherein the at least one time-varying reactive component includes a time-varying capacitor.

6. The antenna assembly of claim 1, wherein the at least one time-varying reactive component includes at least one of a varactor diode, a ferroelectric material, a transistor, a piezoelectric material, a Josephson junction, a non-linear element, or a microelectromechanical system.

7. The antenna assembly of claim 1, wherein the at least one time-varying reactive component is coupled to one or more of the at least two sectors of the electrically small antenna.

8. The antenna assembly of claim 1, further comprising a port electrically coupled with the at least two sectors,
wherein the at least one time-varying reactive component is coupled to a port of the electrically small antenna.

9. The antenna assembly of claim 1, wherein a wave number in a radiating medium multiplied by a radius of a smallest sphere enclosing the electrically small antenna is less than 0.5.

10. The antenna assembly of claim 1, wherein:
wherein the at least two sectors are coupled to operate in at least a third mode;
the first mode and the second mode are coupled according to a first modulation frequency; and
the first mode and a third mode are coupled according to a second modulation frequency different from the first modulation frequency.

11. The antenna assembly of claim 1, wherein the parametric modulation frequency of at least one time-varying reactive component is less than a frequency value which exactly couples the resonance of the radiative mode to the negative frequency of the non-radiative mode.

12. The antenna assembly of claim 1, wherein the parametric modulation frequency of the at least one time-varying reactive component is greater than a frequency value which exactly couples the resonance of the radiative mode to the negative frequency of the non-radiative mode.

13. The antenna assembly of claim 1, wherein:
the electrically small antenna is a rotationally symmetric electrically small antenna; and
the electrically small antenna is divided into N identical sectors.

14. The antenna assembly of claim 11, wherein components in each of the at least two sectors are modulated with the same temporal modulation periods.

15. The antenna assembly of claim 1, wherein each of the at least two sectors has a time delay in its modulation waveform as compared to other ones of the at least two sectors.

16. The antenna assembly of claim 14, wherein the electrically small antenna is configured to operate according to spatially-discrete traveling-wave modulation.

17. The antenna assembly of claim 1, wherein the at least two sectors are electrically connected in parallel.

18. The antenna assembly of claim 1, wherein a topology of the electrically small antenna is at least one of a top hat monopole, a square antenna, or a patch antenna.

19. An antenna assembly comprising:
an electrically small antenna having at least two sectors, wherein the at least two sectors are coupled to operate in at least a first mode and a second mode; and
at least one time-varying reactive component having a parametric modulation frequency configured to at least partially couple a resonance of the first mode to a negative frequency resonance of the second mode,
wherein the parametric modulation frequency of the at least one time-varying reactive component is greater than or less than a frequency value which exactly couples the resonance of the first mode to the negative frequency resonance of the second mode, to operate the electrically small antenna according to spatially-discrete traveling-wave modulation.

20. An antenna assembly comprising:
an electrically small antenna having at least two sectors, wherein the at least two sectors are coupled to operate in at least a first mode and a second mode; and
an electrically small antenna having at least two sectors, wherein the at least two sectors are coupled to operate in at least a first mode and a second mode; and
at least one time-varying reactive component having a parametric modulation frequency configured to at least partially couple a resonance of the first mode to a negative frequency resonance of the second mode,
wherein the parametric modulation frequency of the at least one time-varying reactive component is greater than or less than a frequency value which exactly couples the resonance of the first mode to the negative frequency resonance of the second mode, and
wherein the at least two sectors are electrically connected in parallel.
